(19) United States
(12) Patent Application Publication
(10) Pub. No.: US 2011/0197267 A1
(43) Pub. Date: Aug. 11, 2011

(54) SECURE AUTHENTICATION SYSTEM AND METHOD

(76) Inventors: Vivianne GRAVEL, Longueuil (CA); Francis Gagnon, Montreal (CA); Martin Leclerc, Pointe-Claire (CA); Mathieu Hemon, Montreal (CA); François Gagnon, Lachine (CA)

(21) Appl. No.: 13/021,140

(22) Filed: Feb. 4, 2011

Related U.S. Application Data
(60) Provisional application No. 61/301,658, filed on Feb. 5, 2010.

(51) Int. Cl. H04L 9/32

(52) U.S. Cl. 726/5

(57) ABSTRACT

There is disclosed a system and method for authenticating the identity of a user of a client device as part of a transaction between the client device and a server of a service provider over a communications network, the client device comprising a unique identifier. The system and method comprise one or more personal identification elements issued to the user based upon an initial authentication of the identity of the user, a credential issued to the client device by the service provider based upon the personal identification elements and the unique identifiers, and a trigger event for launching an authentication application installed on the client device. When the authentication application is launched by the trigger event, the authentication application transmits the one or more personal identification elements and the unique identifier in a combination with the credential to the server for authentication by the service provider.

### CROSS REFERENCE TO RELATED APPLICATIONS

The present application claims benefit, under 35 U.S.C. §119(e), of U.S. provisional application No. 61/301,658 filed on Feb. 5, 2010 which is incorporated herein in its entirety by reference.

### FIELD OF THE INVENTION

The present invention relates to a secure authentication system and method for mobile devices. In particular, the present invention relates to an authentication system and method for authenticating the identity of a mobile device user during a transaction between a server and a user's mobile client device using a strong authentication scheme.

### BACKGROUND OF THE INVENTION

As the variety and frequency of online transactions effectuated with mobile devices over telecommunication networks increase, so too does the need to prevent identity theft and online fraud by verifying the identities of the mobile device users participating in such transactions. To do so, authentication schemes are utilized to provide the necessary transactional security and identity assurances for service providers who offer various types of online services to mobile device users. Examples of such authentication systems and methods include network access authentication, mobile IP authentication, and key exchange protocols.

In a basic online authentication scheme, identity authentication is achieved by verifying something that an entity knows, such as the conjunction of a password and a username. However, basic authentication schemes provide minimal security as the elements that an entity knows can be difficult to control. This lack of control can in turn result in a compromised identity. Strong authentication, in contrast, can be employed to enhance the security of basic authentication schemes. In particular, strong authentication, also known as two-factor authentication, utilizes a combination of two different components to authenticate the identity of an entity. Typically, the most common implementations of two-factor authentication schemes consist of verifying two of the three following components: a “something you know” component such as a Personal Identification Number (PIN) or password; a “something you own” component such as a physical device or a token; or a “something you are” component such as a fingerprint or a biometric scan. Virtual tokens are known in the art to replace “something you have” components with an entity's internet device, such as a mobile phone.

While the prior art reveals a variety of strong authentication systems used for online transactions performed via a mobile device, a drawback of these authentication systems is that they lack a combination of security and usability. In particular, prior art strong authentication security systems use complex passwords and security tokens which are logistically complex, costly and user hostile. Furthermore, the prior art fails to show the establishment of a link between the user and the mobile device itself used in a strong authentication system for enhanced security.

### SUMMARY OF THE INVENTION

The present invention relates to a system for authenticating the identity of a user of a client device as part of a transaction between the client device and a server of a service provider over a communications network, the client device comprising a unique identifier. The system comprises one or more personal identification elements issued to the user based upon an initial authentication of the identity of the user, a credential issued to the client device by the service provider based upon the personal identification elements and the unique identifiers, and a trigger event for launching an authentication application installed on the client device. When the authentication application is launched by the trigger event, the authentication application transmits the one or more personal identification elements and the unique identifier in a combination with the credential to the server for authentication by the service provider.

Additionally, there is also disclosed a method of authenticating the identity of a user of a client device as part of a transaction between the client device and a server of a service provider over a communications network, the client device comprising a unique identifier. The method comprises issuing one or more personal identification elements to the user based upon an initial authentication of the user, issuing a credential to the client device based upon a transmission from the client device of said one or more personal identification elements and the unique identifiers, triggering the launch of an authentication application installed on the client device, transmitting said one or more personal identification elements and said unique identifier in a combination with said credential to said server, and authenticating the user by comparing said transmitted combination with said issued one or more personal identification elements and said credential.

Other objects, advantages and features of the present invention will becomes apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows a schematic diagram of an infrastructure employing a strong mobile authentication system;

FIG. 2 shows a flow diagram illustrating a strong mobile authentication system in accordance with an illustrative embodiment of the present invention;

FIG. 3 shows a diagram exemplifying the exchange of communications between a mobile device and a service provider during the strong authentication process of FIG. 2;

FIGS. 4A and 4B provide a schematic diagram exemplifying the exchange of communications of an initial authentication process between a remote mobile device and a service provider in accordance with an illustrative embodiment of the present invention;

FIG. 5 provides a schematic diagram exemplifying the exchange of communications of an strong authentication process between a remote mobile device and a service provider in accordance with an illustrative embodiment of the present invention;

FIG. 6 provides a schematic diagram of an exemplary voting process employing strong authentication effectuated between a voter using a remote mobile device and a voting service provider;

FIG. 7 provides a schematic diagram of an exemplary online purchasing process between a consumer using a remote mobile device and a merchant service provider using the strong authentication system of FIG. 2; and

FIG. 8 provides a schematic diagram exemplifying the exchange of communications of a strong authentication process between the consumer using a remote mobile device and the merchant service provider of FIG. 7.

### DESCRIPTION OF ILLUSTRATIVE EMBODIMENTS

The present invention is illustrated in further detail by the following non-limiting examples.

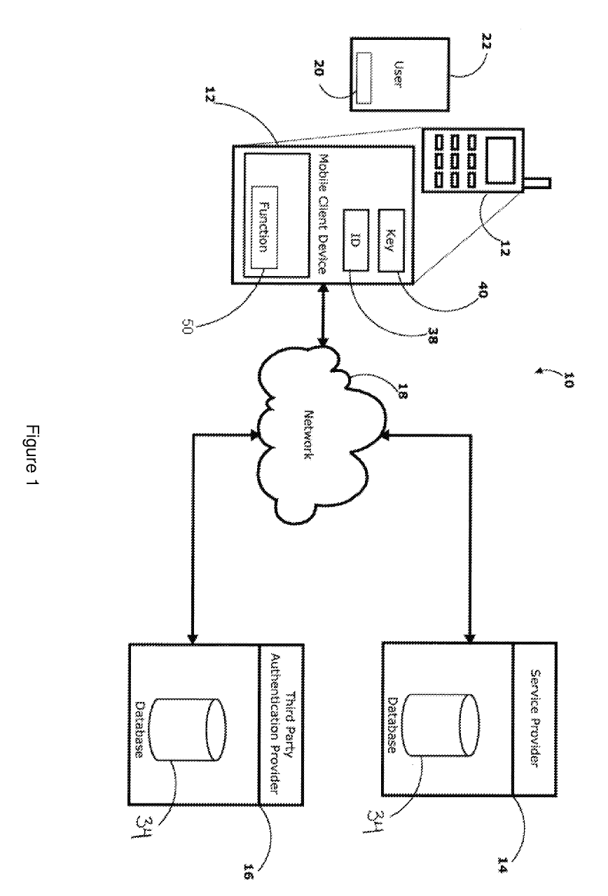

Referring to FIG. 1, a strong authentication system and method will now be described in the context of an exemplary communications system. The strong authentication system 10 comprises a mobile client device, or terminal, 12, such as a cell phone, a PDA, a Smartphone, or the like. The strong authentication system 10 further comprises a service provider 14 and a third party authentication provider 16. The mobile client device 12, the service provider 14, and the third party authentication provider 16 are placed in communication with each other via a communications network 18, which may comprise a telephony network, a Wireless Wide Area Network (WWAN), the Internet, a Wi-Fi network, a Bluetooth network, Near Field Communication or the like depending on the communication capabilities of the mobile client device 12. The identity 20 of a user 22 operating the mobile client device 12 and performing a transaction with a service provider 14 via the communications network 18 will be authenticated by either the service provider 14 or by a service provider 14 in conjunction with the third party authentication provider 16 implementing a strong authentication system and method as described herein below.

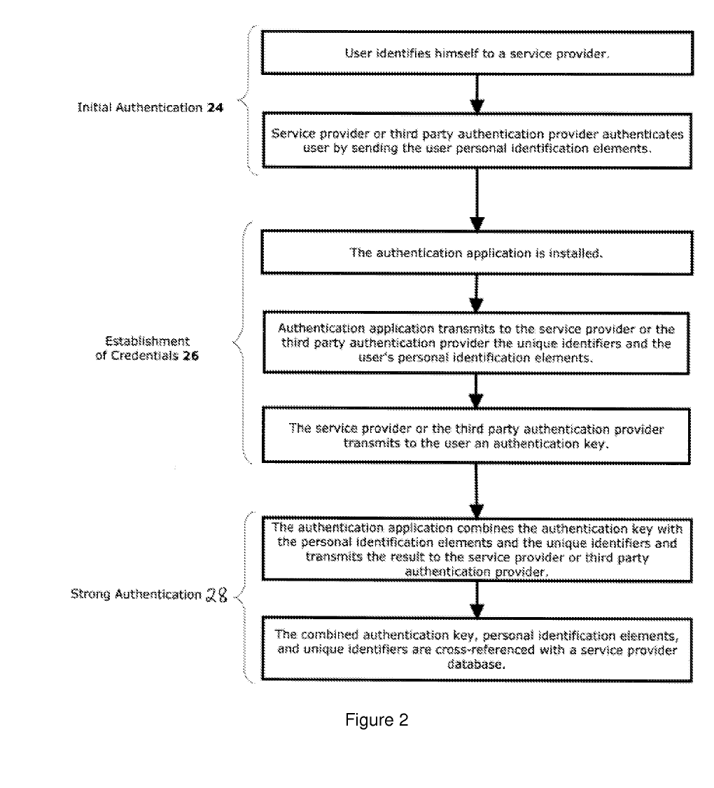

Referring now to FIG. 2, in addition to FIG. 1, the process of authenticating the identity of a user 22 as part of an online transaction, such as the purchase of a product on a website, or any other type of transaction between a mobile client device 12 and a service provider 14 that requires the authentication of the identity of a user 22, illustratively comprises an Initial Authentication 24, followed by an Establishment of Credentials 26, and a Strong Authentication 28. The Initial Authentication 24 and the Establishment of Credentials 26 are distinct and separate operations from the Strong Authentication 28. For the purposes of Initial Authentication 24, it is assumed that the mobile client device 12 has validated the identity of the service provider 14 through methods that are known in the art that can be used to establish a trust therewith, for instance by use of public key infrastructure.

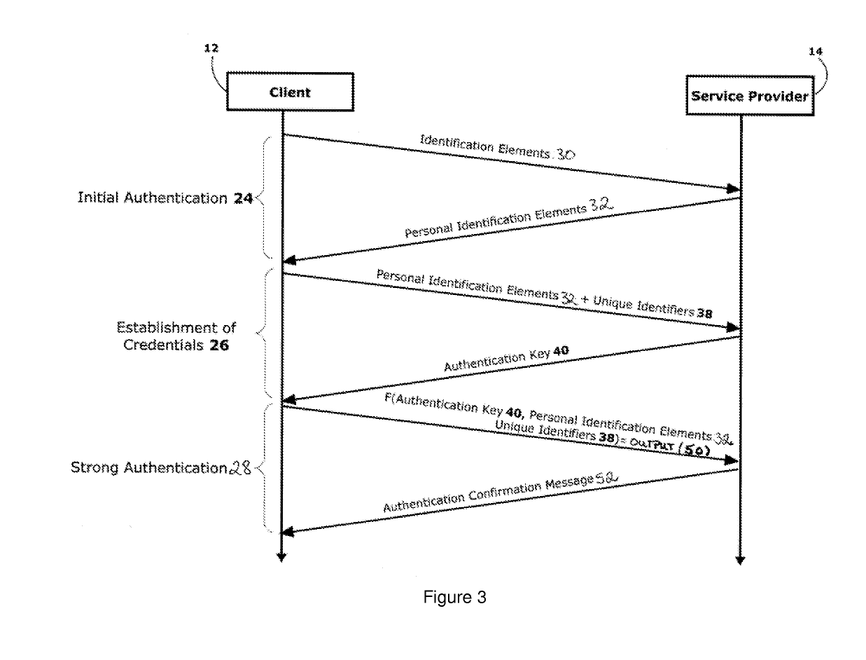

Referring now to FIG. 3, in addition to FIG. 2 and FIG. 1, the method of strongly authenticating the identity of the user 22 of the mobile client device 12 during a transaction between a service provider 14 and a user's mobile client device 12 using the strong authentication system 10 is now described. Initial Authentication 24 illustratively comprises a registration of the user 22 of the mobile client device 12 with the service provider 14 that will eventually furnish a service to the user 22. Initial Authentication 24 is illustratively undertaken for each distinct service offered by the service provider 14 to which the user 22 desires to benefit from. This registration requires the establishment and exchange of identification elements 30 between the user 22 and the service provider 14 to permit the recognition of one another. For example, typically exchanged identification elements 30 include a name, a user code, or an account number, or the like, or a combination thereof. Note, Initial Authentication 24 is independent of the mobile client device 12 and the exchange of identification elements 30 can be achieved over a variety of communication channels. For example, such identification information could be exchanged electronically via the Internet, a Wireless Application Protocol (WAP) or Short Message Service (SMS). Alternatively, identification elements 30 can be communicated physically, for example by having the user 22 present himself at the service provider's 14 physical premises or by communicating with the service provider 14 via telephone. While the exchange of identification elements 30 has been illustratively shown to be accomplished by the user employing the mobile client device 12 via the communications network 18, other ways of exchanging identification elements 30 will also be known to a person skilled in the art. Initial Authentication 24 requires a validation, by the service provider 14, of the information specific to the user 22. Such information should be easily verifiable. Once verified, the user 22 will be issued personal identification elements 32 such as a shared secret code and/or a Personal Identification Number (PIN), or the like, via the same or alternative communication channels.

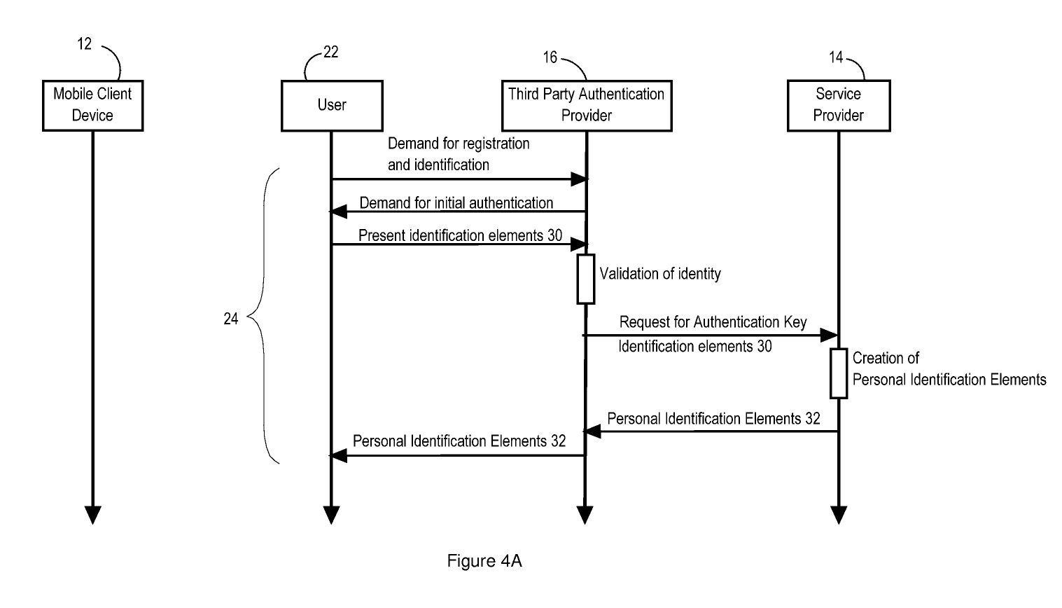

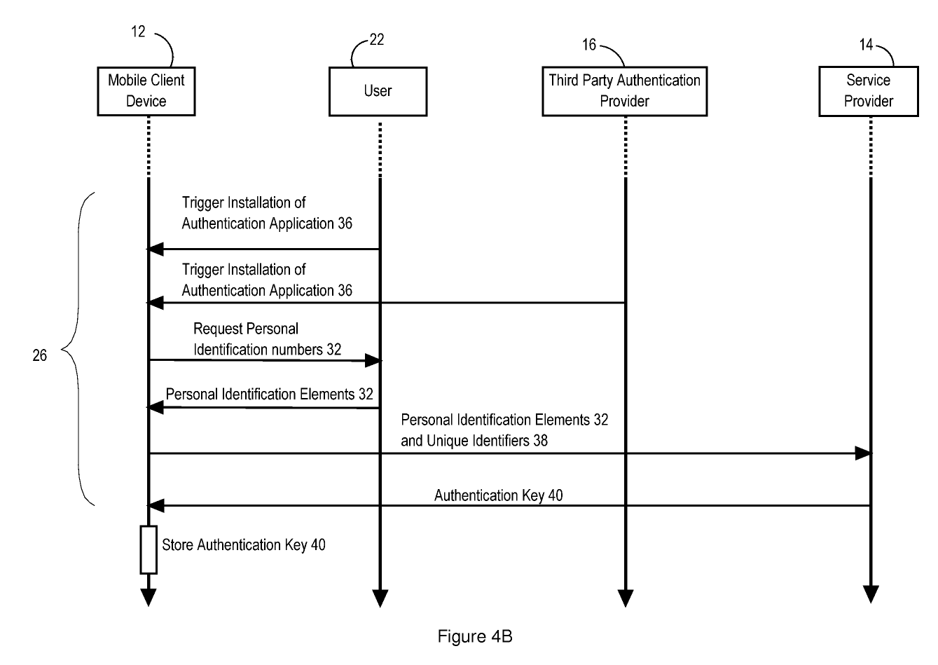

Now referring to FIGS. 4A and 4B, in addition to FIG. 3, in another embodiment of the present invention, it is equally possible to use the services of the third party authentication provider 16 to initially authenticate the user 22. For example, in a case where the user 22 desires to register for one or more services offered by the service provider 14, the service provider 14 can proceed with Strong Authentication 28 based on a user's 22 prior Initial Authentication 24 with the third party authentication provider 16. The identity 20 of this user 22 is confirmed and noted with a third party authentication provider 16 prior to the use of services offered by a service provider 14. Illustratively, identification elements 30 including a name, a user code, an account number, or the like, are exchanged with the third party authentication provider 16 which verifies the identity of the user 20. Once verified, the third party authentication provider 16 issues a request for Personal Identification Elements 32 from the service provider 14 which trusts the identification of the user 22 by the third party authentication provider 16. Upon such a request, the service provider 14 generates and stores the Personal Identification Elements 32 on a database as in 34 and returns them to the third party authentication provider 16 which will subsequently return the Personal Identification Elements 32 to the user 22. In an alternative embodiment of the present invention the Initial Authentication 24 of the user 22 by a third party authentication provider 16 may be insufficient for the security needs of certain service providers 14 which require users 22 to be identified with the service providers 14. In this case, the service provider 14 will undertake the verification of the identity of the user 22, generate and store the Personal Identification Elements 32 on a database as in 34 subsequently return the Personal Identification Elements 32 to the user 22.

Still referring to FIGS. 4A and 4B, in addition to FIG. 1, following Initial Authentication 24 is the Establishment of Credentials 26. The Establishment of Credentials 26 allows the extension of a chain of trust to include the mobile client device 12. The information issued to the user 22 and illustratively stored in memory (not shown) on the mobile device 12 as part of this process of associating the user 22 with the mobile client device 12 is known as a credential (or alternatively, credential). The Establishment of Credentials 26 will link the Personal Identification Elements 32, or the “something you know” of the user 22 with the mobile client device 12, or the “something you own” of the user 22. These credentials will be necessary to complete Strong Authentication 28 as they will be cross-referenced with information stored on the service provider's 14 database as in 34 during the Initial Authentication 24 and the Establishment of Credentials to confirm the authentication of a user 22 during Strong Authentication 28. Note, other validation elements in addition to credentials can be cross-referenced with elements stored on the database as in 34.

Still referring to FIGS. 4A and 4B, in addition to FIG. 1, the Establishment of Credentials 26 comprises a chain of events which creates a relationship of trust between the mobile client device 12 and the service provider 14. In other words, a link between the mobile client device 12 and an authentication application 36 installed on the mobile client device 12 will be formed. Certain elements such as the telephone number, the mobile device's 12 IP address, or a unique identifier of the mobile device such as the International Mobile Subscriber Identity (IMSI) or the like, may be employed as part of this process as will be described hereinbelow. The creation of this link illustratively requires the installation of the authentication application 36 on the mobile client device 12. For example, this will illustratively involve the execution of code, in the form of software or otherwise, on the mobile client device 12. The mobile client device 12 as operated by the user 22 during a transaction with a service provider 14 will therefore be directly implicated in the Establishment of Credentials 26.

Of note, to maintain a robust level of security in the strong authentication system 10, it is advantageous that the mobile client device 12 is capable of authenticating, without error, the identity of the service provider 14 which provides it information. This assurance may be intrinsic to the manner in which information is provides, for example through the iPhone AppLink, or this assurance may be provided through the employment of public key encryption whereby decryption of messages received from the service provider 14 is performed by the authentication application 36.

Still referring to FIGS. 4A and 4B in addition to FIG. 1, the Establishment of Credentials 26 will now be described. The user 22, who has previously registered to a service by Initial Authentication 24, may illustratively launch the execution of the authentication application 36 used to offer the service for which a user 22 has registered for. Once launched, the authentication application 36 captures the unique identifiers 38 of the mobile client device 12. This process may illustratively involve capturing the unique mark and the model identifier of the mobile client device 12, its operating system identifiers, the user preferences and/or any other combination of elements that are utilized to uniquely identify the mobile device 12. For example, these unique identifiers 38 may illustratively include: the identification of a physical key of the mobile client device 12 such as the ESN (Electronic Serial Number), the IMEI (International Mobile Equipment Identity), the Mobile Station International Subscriber Directory Number (MSISDN), the Bluetooth ID, the MAC address, etc.; the identification of a logical key of the mobile client device 12 such as the telephone number, the Blackberry PIN, etc.; the identification of the logical key of the operating system such as the Windows Mobile Device ID; and other identifiers that will be known to a person skilled in the art.

Still referring to FIGS. 4A and 4B in addition to FIG. 1, once the unique identifiers 38 are captured, the authentication application 36 prompts the user 22 to authenticate himself with the help of the personal identification elements 32, such as a secret code, which where issued to the user 22 along with a PIN during Initial Authentication 24. Of note, the PIN may be ulteriorly modified by the user 22 via the authentication application 36. The authentication application 36 communicates with the service provider 14 and transmits the captured unique identifiers 38 along with the personal identification elements 32. Upon reception of this information, the service provider 14 then generates an authentication key 40 based on these elements and illustratively by using an encryption function, records the authentication key 40 on its database as in 34, and transmits the authentication key 40 to the mobile client device 12 for storage in memory (not shown) and ulterior consultation during Strong Authentication 30. Of note, such a consultation of the authentication key 40 may or may not be required however. The link between the mobile client device 12 and the user 22 is thus created and the chain of trust is extended to include the mobile client device 12. This link will allow the user 22 to strongly authenticate himself by using “something he owns”, in this case his mobile client device 12 illustratively verifiable by the authentication key 40, in conjunction with “something he knows” such as his personal identification elements 32 comprising a PIN.

Still referring to FIGS. 4A and 4B in addition to FIG. 1, the authentication application 36 used in the Establishment of Credentials 26 is installed on the mobile client device 12 in several manners: it can be pre-installed on the mobile client device 12 by the manufacturer, the service supplier, or the vendor which distributes the mobile client device 12 to the user 22. Alternatively, the authentication application 36 can be downloaded by the user 22 as a result of the registration process during Initial Authentication 24 onto the mobile client device 12 over a wireless network, a cellular network, the Internet, a Wi-Fi network, a Bluetooth network, Near Field Communication, a connection established with a computer or any other form of communications network 18 that the mobile client device 12 is capable of using. Other methods of installing the authentication application 36 which are known to a person skilled in the art may also be employed. In a case where a portion or all of the executable code of the authentication application 36 is absent from the mobile client device 12, a variety of installation triggers can be used, alone or in combination, to initiate the installation of the authentication application 36. Of note, this installation process is achieved with minimum user intervention. The installation trigger can be in any number of forms. Examples of such installation triggers include information pushed towards the mobile client device 12 by Wireless Application Push (WAP), by push application software such as iPhone Applink, BlackBerry BIS-B Push and WEB Signals, etc., by e-mail, by Near Field Communications, and other methods. The installation of the authentication application 36 can also be triggered by information pulled from the mobile client device 12 through initiators such as the transmission by a user 22 of an SMS message comprising a key word or a short number, the transmission by a user 22 of an e-mail containing a certain subject to a given address, or the downloading of an authentication application 36 from a server such as AppStore, AppWorld, Android Market, or Windows marketplace. The installation of the authentication application 36 may also be initiated as a result of registration of the user 22 to a service. Other methods of triggering the installation of the authentication application 36 which are known to a person skilled in the art may be used.

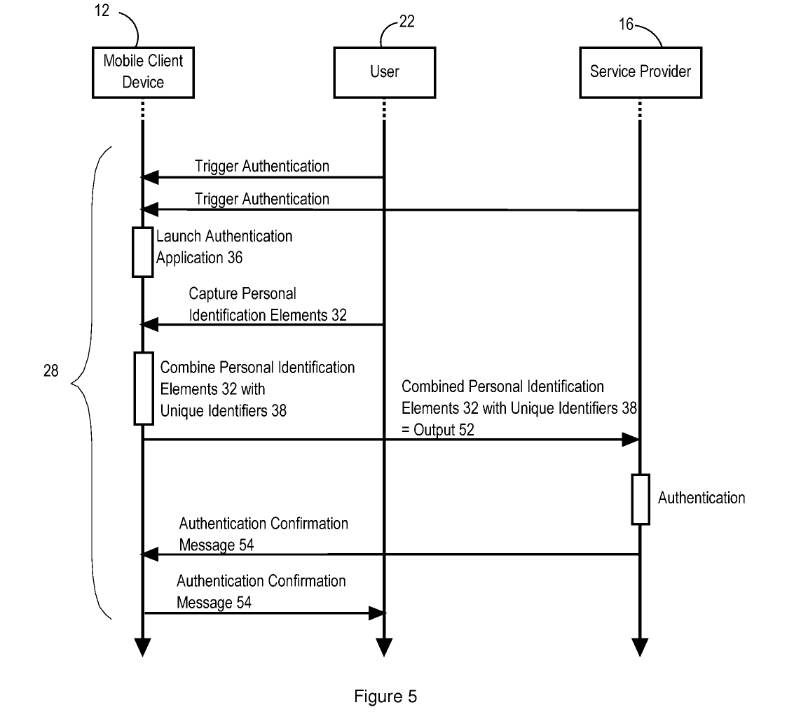

Now referring to FIG. 5, in addition to FIG. 1 and FIG. 4, Initial Authentication 24 and Establishment of Credentials 26 are but a separate and distinctive part of the entire strong authentication system 10 and are untaken only once for registration to a given service to permit a multitude of future transactions employing Strong Authentication 28. It is during Strong Authentication 28 that the user 22 of a given service benefits, in a friendly and efficient manner, from the elements previously put in place during Initial Authentication 24 and Establishment of Credentials 26. The initiation of Strong Authentication 28 by an authentication trigger event, which is illustratively a demand for authentication, stemming from a vendor, an emitter of an instrument of payment such as a credit card, or from an institution offering a service, such as a security company. The trigger could include a message transmitted to the mobile client device 12 from the service provider 14 and directed to the authentication application 36. Similarly, a trigger in the form of a communication message can also be sent from a third party authentication provider 16. In an alternative embodiment, the user 22 triggers the launch of the authentication application 36 by taking a positive action which implicitly demands a Strong Authentication 28, such as the registration of a vote by the launch of a voting application on the mobile client device 12. In yet another embodiment the user 22 manually launches the authentication application 36, for instance by accepting a request from a web merchant to proceed with a Strong Authentication 28. Other methods of triggering the launch of the application, through other communication channels for example, will be known to a person skilled in the art. Communication messages sent to the authentication application 36 may also be of various natures for the purpose of triggering different actions to be undertaken by the authentication application 36. For instance, the transmission of a communication message to the authentication application 36 may be done to render the application inactive, or alternatively, active. In another embodiment, a communication message transmitted to the authentication application 36 may trigger the automatic deletion of credentials or sensitive information, such as the authentication key 40 and the personal identification elements 32, stored on the application's cache or mobile device's 12 internal memory (not shown).

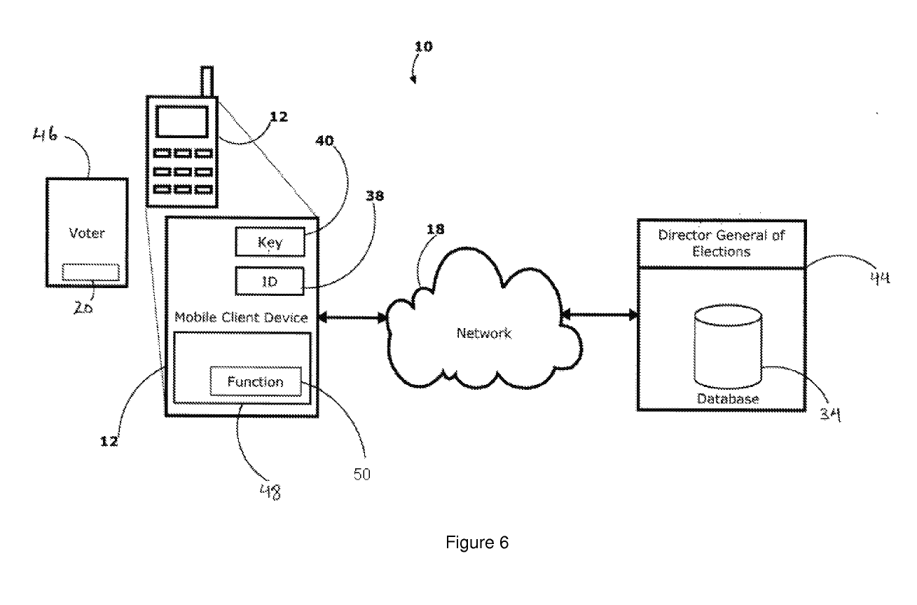

Now referring to FIG. 6, in addition to FIG. 5, an illustrative example of a strong authentication system 10 wherein the service provider 14 is the Chief Electoral Officer (CEO) 44 and the user 22 is a voter 46 who desires to register his vote with the CEO 44 is depicted. In this example, the voter 46 has previously been identified by the CEO 44, the voting authentication application 36 has been installed on his mobile client device 12, and the voter 46 now desires to register his vote. To do so, the voter 46 triggers the launch of the authentication application 36, or in accordance with this illustrative example, the Vote 2011 application 48. In the present illustrative example, a third party authentication provider 16 is not employed to initially authenticate the voter 46, but rather the CEO 44 initially authenticates the voter 46 to satisfy its security requirements.

Still referring to FIG. 5 and FIG. 6, the Vote 2011 application 48 presents the candidates for election to the voter 46 and prompts the voter 46 to select a candidate for whom he desires to register his vote for. Once a selection is made, the Vote 2011 application 48 requests the voter 46 confirm his or her selection. Once the selection is confirmed, the Vote 2011 application 48 may illustratively interrogate the voter 46 by prompting for his or her name. The Vote 2011 application 48 can equally interrogate the voter 46 to furnish one, or multiple complementary identification elements 32 depending on the authentication needs of the voting system. An example of such an element could be the user's 12 telephone number. A function 50 is then illustratively applied to combine the personal identification element 32 such as the PIN of the voter 46 with the unique identifiers 38 and authentication key 40 that had been stored on the mobile client device 12 during Initial Authentication 24 and Establishment of Credentials 26 to produce a function output 52. The function 50 is typically an encryption process utilising a public key and/or a precise identifier issued by the server of the CEO 44. Such encryption will permit a secure and authenticated communication between the mobile client device 12 and CEO 44 that is difficult to intercept. The function output 52 is subsequently transmitted to the CEO 44. A comparison of the function output 52 with data previously stored on the CEO's databases as in 34, such as the authentication key 40, the personal identification elements 32 and the unique identifiers 38, is undertaken either to confirm or reject the authenticity of the voter 46. The comparison can be equally undertaken with data previously stored on a third party authentication provider's 16 databases as in 34 to which the CEO 48 has access. The vote is registered if the identity of the voter 46 is authenticated, or rejected if the identity of the voter 46 is not authenticated and an authentication confirmation message 54 informing of the success or rejection of the voting process is transmitted to the voter 46.

Still referring to FIG. 6, in a further embodiment of the above exemplary strong authentication system 10, the activation of the voting authentication application 36, the Vote 2011 application 48, may be delayed until the day of elections. It suffices that the Vote 2011 application 48 had been pre-installed and remained dormant until such time as the servers of the CEO 44 send an appropriate activation message towards the mobile client device 12. Such an activation message or code may be sent to the mobile client device 12 via SMS, push applications or via other methods based on capabilities of the mobile client device 12. Other methods by which the application activates itself will be known to a person skilled in the art.

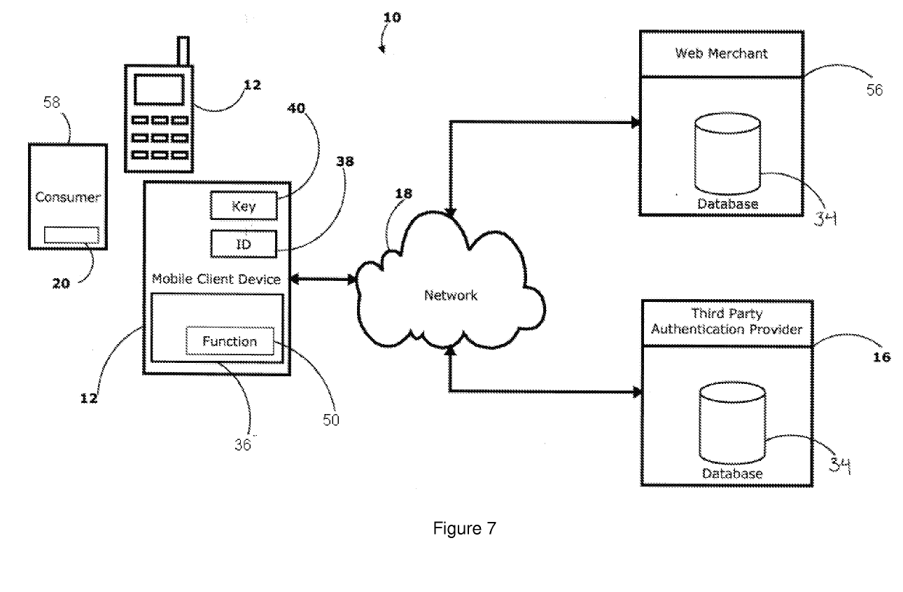

Now referring to FIG. 7, an illustrative example of an embodiment of a strong authentication system 10 wherein the service provider 14 is a web merchant 56 is depicted. This embodiment demonstrates employing a third party authentication provider 16 to authenticate the identity 20 of a user 22, a consumer 58. In this example, the consumer 58 navigates the website (not shown) of the web merchant 56 utilizing his web enabled mobile client device 12 to fill a virtual basket (also not shown) with the article or articles that the consumer 58 desires to purchase. Once the consumer 58 decides to effectuate payment of the selected articles, the consumer 58 proceeds with a checkout process.

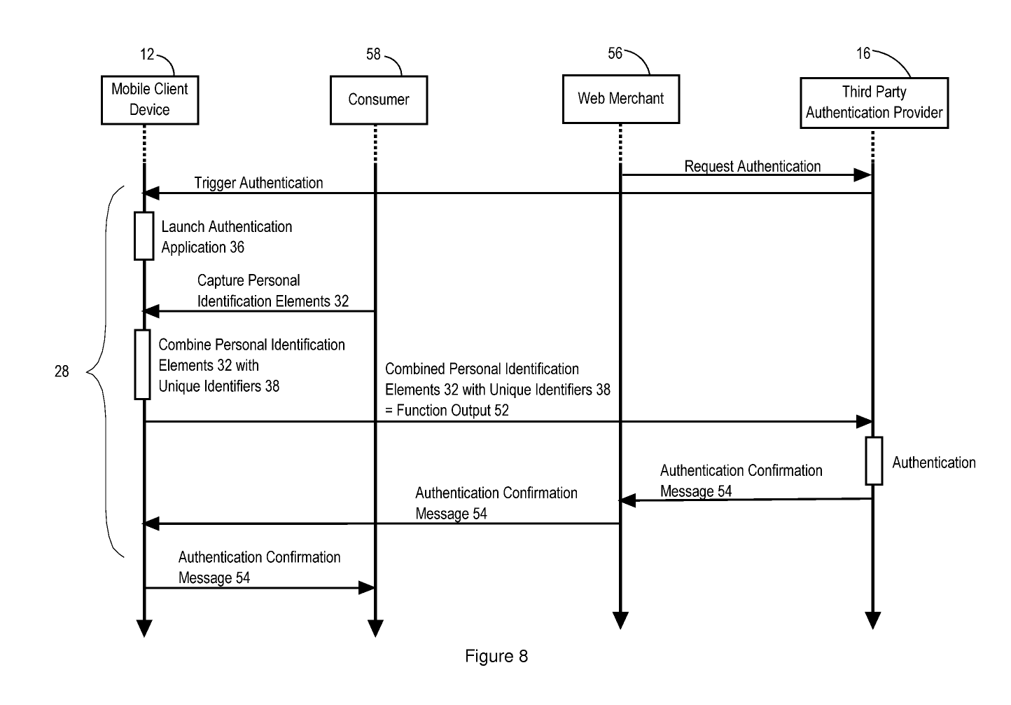

Now referring to FIG. 8, in addition to FIG. 7, the website of the web merchant 56 offers the consumer 58 the possibility to authenticate himself with the help of the authentication application 36 and a third party authentication provider 16 to which his identity 20 has previously be authenticated by. Once the consumer 58 accepts the request for Strong Authentication 28 by the web merchant 56, the servers of the web merchant 56 transmit to the third party authentication provider 16 a demand for authentication. The third party authentication provider 16 transmits a request to the mobile client device 12 of the consumer 56 thereby automatically launching the third party authentication application 36 residing on the mobile client device 12. The consumer 58 accepts the access demand third party authentication provider 16 and the third party authentication application 36 subsequently prompts the consumer 58 to identify himself with the help of his personal identification elements 32, such as a PIN, which has been previously communicated to the consumer 56 during Initial Authentication 24 for combination with the authentication key 40 previously communicated to the mobile client device 12 during Establishment of Credentials 26. The authentication application 36 can equally prompt the consumer 58 to furnish one or more complementary elements, such as the consumer's 58 mobile telephone number, necessary for the authentication needs of the merchant 56. A function 50 is applied to combine the personal identification elements 32, for example the PIN of the consumer 58, and other requested elements with the unique identifiers 38 and the authentication key 40 previously stored on the mobile client device 12. The function output 52 resulting from the application of the function 50 is transmitted to the third party authentication provider 16 which proceeds with a comparison between data already present on the databases as in 34 of the third party authentication provider 16. The third party authentication provider 16 either confirms or rejects the authentication of the consumer 58 based on a positive or negative comparison. An authentication confirmation message 54 is transmitted to the merchant 56 to confirm or reject authorisation to proceed with the requested purchase. If the identity of the consumer 58 is authenticated, the purchasing process continues as normal whereby payment and delivery information is collected from the user 22. Note, the use of a payment instrument can be linked to the third party authentication.

Although the present invention has been described hereinabove by way of embodiments thereof, it may be modified, without departing from the nature and teachings of the subject invention as defined in the appended claims.

1. A system for authenticating an identity of a user of a client device as part of a transaction between the client device and a server of a service provider over a communications network, the client device comprising a unique identifier, the system comprising:
one or more personal identification elements issued to the user based upon an initial authentication of the identity of the user;
a credential issued to the client device by the service provider based upon said personal identification elements and said unique identifiers; and
a trigger event for launching an authentication application installed on the client device;
wherein when said authentication application is launched by said trigger event, said authentication application transmits said one or more personal identification elements and said unique identifier in a combination with said credential to the server for authentication by the service provider.

2. The system of claim 1, wherein said initial authentication comprises a verification of the identity of the user by the service provider.

3. The system of claim 1, wherein said initial authentication comprises a verification of the identity of the user by a third party authentication provider.

4. The system of claim 3, wherein said credential is issued by the service provider based upon said verification of the identity of the user by said third party authentication provider.

5. The system of claim 1, wherein said authentication application is launched by a trigger event issued by the service provider.

6. The system of claim 5, wherein said trigger event is a communication transmitted from the server to said authentication application.

7. The system of claim 1, wherein said authentication application is launched by a trigger event issued by the user.

8. The system of claim 4, wherein said authentication application is launched by a trigger event issued by a third party authentication provider.

9. The system of claim 1, wherein said authentication application encrypts said combination of said one or more personal identification elements, said unique identifier and said credential prior to transmission to the server.

10. The system of claim 1, wherein said one or more personal identification elements comprise a Personal Identification Number.

11. A method for authenticating an identity of a user of a client device as part of a transaction between the client device and a server of a service provider over a communications network, the client device comprising a unique identifier, the method comprising:
issuing one or more personal identification elements to the user based upon an initial authentication of the user;
issuing a credential to the client device based upon a transmission from the client device of said one or more personal identification elements and the unique identifiers;
triggering the launch of an authentication application installed on the client device;
transmitting said one or more personal identification elements and said unique identifier in a combination with said credential to said server; and
authenticating the user by comparing said transmitted combination with said issued one or more personal identification elements and said credential.

12. The method of claim 11, wherein said initial authentication comprises a verification of the identity of the user by the service provider.

13. The method of claim 12, wherein said authenticating is done by the service provider.

14. The method of claim 11, wherein said initial authentication comprises a verification of the identity of the user by a third party authentication provider.

15. The method of claim 14, wherein said credential is issued by said service provider based upon said verification of the identity of the user by said third party authentication provider.

16. The method of claim 11, further comprising encrypting said combination of said credential with said one or more personal identification elements and said unique identifier prior to transmission to the server.

17. The method of claim 11, wherein said authentication application is launched by a trigger event issued by the service provider.

18. The method of claim 11, wherein said trigger event is a communication transmitted from the server to said authentication application.

19. The method of claim 15, wherein said authentication application is launched by a trigger event issued by said third party authentication provider.

20. The method of claim 19, wherein said authenticating is done by said third party authentication provider.
